(19) United States
(12) Patent Application Publication
(10) Pub. No.: US 2015/0106484 A1
(43) Pub. Date: Apr. 16, 2015

(54) GATEWAY MANAGEMENT SYSTEM, AND METHOD THEREOF

(71) Applicant: POWER-ALL NETWORKS LIMITED, Shatin (HK)

(72) Inventor: STEVE LAP WAI HUI, Shatin (HK)

(21) Appl. No.: 14/511,378

(22) Filed: Oct. 10, 2014

(30) Foreign Application Priority Data
Oct. 16, 2013 (CN) 201310482082.3

(51) Int. Cl. H04L 12/24; H04L 29/08

(52) U.S. Cl. CPC H04L 41/085; H04L 41/28; H04L 67/22
USPC 709/220

(57) ABSTRACT

A gateway configuration management method includes: receiving scanned information comprising address information of a configuration management server obtained by a scanning unit by scanning a scan code of a cloud gateway device; controlling a terminal device to connect to the configuration management server according to the address information; obtaining an unique identifier and a network address of the cloud gateway device after the terminal device is connected to the configuration management server; determining configuration data corresponding to the obtained unique identifier of the cloud gateway device according to relationships between the configuration data and the unique identifiers; sending the configuration data corresponding to the unique identifier to the cloud gateway device according to the network address of the cloud gateway device; and configuring the cloud gateway device according to the configuration data received by the cloud gateway device.

### CROSS-REFERENCE TO RELATED APPLICATIONS

This application claims priority to Chinese Patent Application No. 201310482082.3 filed on Oct. 16, 2013 in the China Intellectual Property Office, the contents of which are incorporated by reference herein.

### FIELD

The present disclosure relates to management systems, and particularly to a gateway management system, and a method thereof.

### BACKGROUND

Nowadays, cloud services, such as cloud storages, cloud applications provided by intercloud (an interconnected global “cloud of clouds” and an extension of the Internet “network of networks” on which it is based) is gradually being adopted by the public. Usually, people can connect to the intercloud via a cloud gateway device. However, the cloud gateway device should be first configured by a specialized technician.

### BRIEF DESCRIPTION OF THE DRAWINGS

Implementations of the present technology will now be described, by way of example only, with reference to the attached figures.

FIG. 1 is a block diagram of a gateway configuration management system.

FIG. 2 is a block diagram of a configuration management service connected to a terminal device, and a cloud gateway device.

FIG. 3 is a diagrammatic view of a management interface provided by the configuration management service of FIG. 2.

FIG. 4 is a flowchart diagram of an embodiment of a gateway configuration management method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like. The connection can be such that the objects are permanently connected or releasably connected.

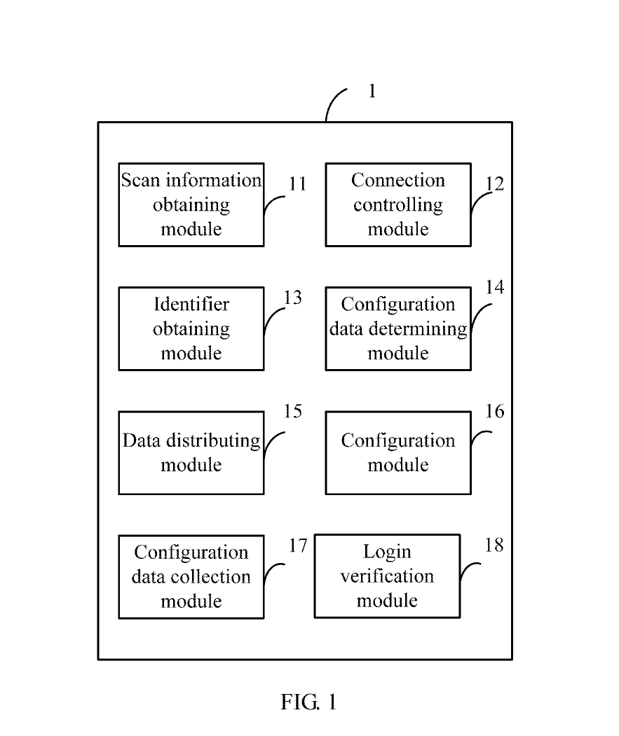

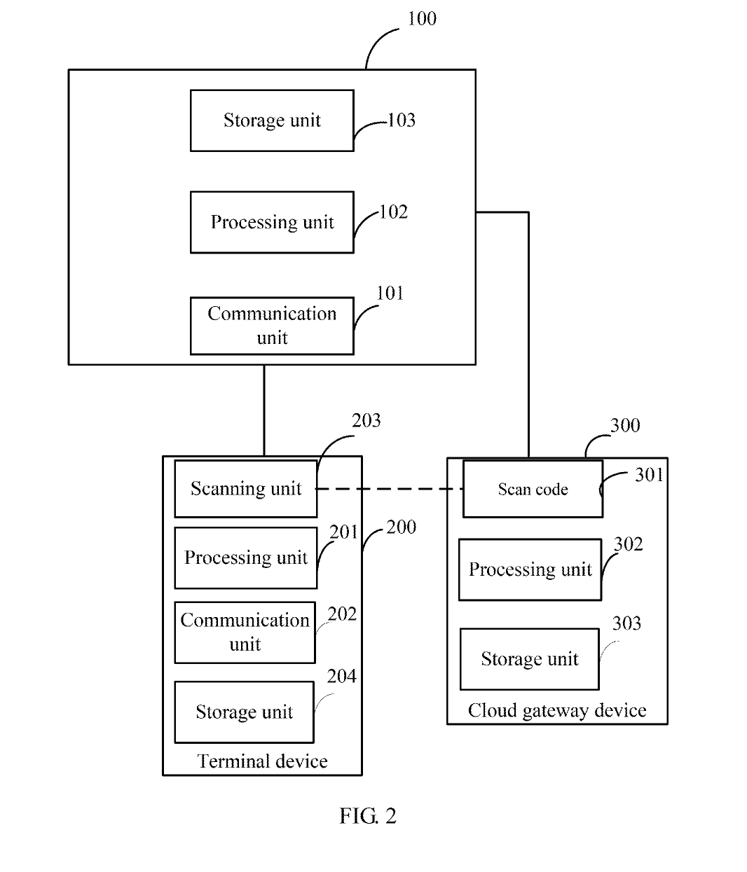

Referring to FIG. 1 and FIG. 2, a gateway configuration management system 1 is illustrated. The gateway configuration management system 1 is run in at least one configuration management server 100, at least one terminal device 200, and at least one cloud gateway device 300 as shown in FIG. 2.

The configuration management server 100 includes a communication unit 101, a processing unit 102, and a storage unit 103. The configuration management server 100 communicates with at least one terminal device 200 and at least one cloud gateway device 300 via the communication unit 101.

The terminal device 200 includes a processing unit 201 and a communication unit 202. The communication unit 202 is used to connect to the communication unit 101 of the configuration management server 100. The terminal device 200 can be a mobile phone, a computer includes, but not limited to, a portable computer, a tablet computer, a desktop computer.

The cloud gateway device 300 can be a router, a switch, or a gateway. The cloud gateway device 300 can further includes a scan code 301, a processing unit 302, and a storage unit 303. The scan code 301 includes an address information of the configuration management server 100. The terminal device 200 further includes a scanning unit 203 and a storage unit 204. The scanning unit 203 can scan the scan code 301 of the cloud gateway device 300 and obtain scanned information including the address information of the configuration management server 100. The scan code can be a two-dimension code or a bar code, and can be adhered on a surface of the cloud gateway device 300. The scanning unit 203 can be a scanner or software installed in the terminal device 200.

The storage unit 103 of the configuration management server 100 stores a number of configuration data and relationships between a number of unique identifiers of different cloud gateway device 300 and the configuration data.

The gateway configuration management system 1 includes a scan information obtaining module 11, a connection controlling module 12, an identifier obtaining module 13, a configuration data determining module 14, a data distributing module 15, a configuration module 16, a configuration data collection module 17, and a login verification module 18. In the embodiment, the scan information obtaining module 11 and the connection controlling module 12 can be a collection of software instructions stored in the storage unit 204 of the terminal device 200 and executed by the processing unit 201 of the terminal device 200. The identifier obtaining module 13, the configuration data determining module 14, the data distributing module 15, the configuration data collection module 17, and the login verification module 18 can be a collection of software instructions stored in the storage unit 103 of the configuration management server 100 and executed by the processing unit 101 of the configuration management server 100. The configuration module 16 can be a collection of software instructions stored in the storage unit 303 of the cloud gateway device 300 and executed by the processing unit 302 of the cloud gateway device 300. The modules of the gateway configuration management system 1 also can include functionality represented as hardware or integrated circuits, or as software and hardware combinations, such as a special-purpose processor or a general-purpose processor with special-purpose firmware.

In another embodiment, the all of modules of the gateway configuration management system 1 can be stored in the storage unit 103 of the configuration management server 100 and executed by the processing unit 101 of the configuration management server 100, or can be stored in the storage unit 204 of the terminal device 200 and executed by the processing unit 201 of the terminal device 200.

In one embodiment, each one of the processing units 101, 201, and 301 can be a central processing unit, a digital signal processor, or a single chip, for example. In one embodiment, each one of the storage units 103, 203, and 302 can be an internal storage system, such as a flash memory, a random access memory (RAM) for temporary storage of information, and/or a read-only memory (ROM) for permanent storage of information. Each one of the storage units 103, 203, and 302 can also be a storage system, such as a hard disk, a storage card, or a data storage medium. Each one of the storage units 103, 203, and 302 can include volatile and/or non-volatile storage devices. In at least one embodiment, each one of the storage units 103, 203, and 302 can include two or more storage devices such that one storage device is a memory and the other storage device is a hard drive. Additionally, one or more of the storage units 103, 203, and 302 can be respectively located either entirely or partially external relative to the configuration management server 100, the terminal device 200, and the cloud gateway device 300.

The scan information obtaining module 11 is used to receive the scanned information including the address information of the configuration management server 100 obtained by the scanning unit 203 by scanning the scan code 301 of the cloud gateway device 300.

The connection controlling module 12 is used to control the communication unit 202 of the terminal device 200 to connect to the configuration management server 100 according to the address information of the configuration management server 100. Thus to connect the terminal device 200 to the configuration management server 100.

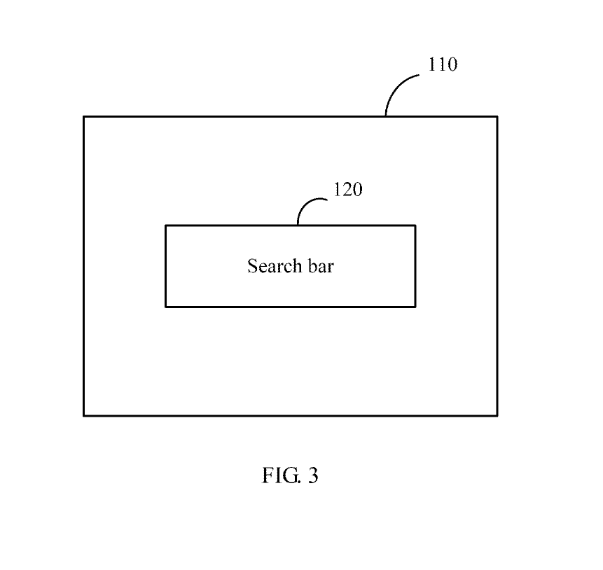

Referring also to FIG. 3, in the embodiment, the address information of the configuration management server 100 is a website address of a management interface 110 provided by the configuration management server 100. The connection controlling module 12 controls the communication unit 202 of the terminal device 200 to connect to the management interface 110 of the configuration management server 100, thus to connect the terminal device 200 to the configuration management server 100.

The identifier obtaining module 13 is used to obtain an unique identifier of the cloud gateway device 300 and a network address of the cloud gateway device 300 after the terminal device 200 is connected to the configuration management server 100. In the embodiment, the scan code 301 of the cloud gateway device 300 further includes the unique identifier of the cloud gateway device 300. When the scanning unit 203 scans the scan code 301, the scanned information obtained by the scanning unit 203 further includes the unique identifier of the cloud gateway device 300. Therefore, the scanned information received by the scan information obtaining module 11 also includes the unique identifier of the cloud gateway device 300. The identifier obtaining module 13 obtains the unique identifier of the cloud gateway device 300 from the scan information obtaining module 11 when the terminal device 200 is connected to the configuration management server 100.

In another embodiment, when the connection controlling module 12 controls the terminal device 200 to connect to the configuration management server 100 according to the address information of the configuration management server 100, the connection controlling module 12 provides an identifier input box to the terminal device 200, thus to provide a user of the terminal device 200 to input the unique identifier of the cloud gateway device 300 via the identifier input box. The identifier obtaining module 13 obtains the unique identifier of the cloud gateway device 300 when the user of the terminal device 200 inputs the unique identifier of the cloud gateway device 300 via the identifier input box. In the embodiment, the identifier input box can be an input box included in the management interface 110 of the configuration management server 100.

In one embodiment, the unique identifier and the network address of one cloud gateway device 300 are stored in the storage unit 103 of the configuration management server 100 by associating each other. The identifier obtaining module 13 obtains network address associated with the unique identifier of the cloud gateway device 300, after obtaining the unique identifier of the cloud gateway device 300. In detail, the unique identifier and the network address of one cloud gateway device 300 are stored in the storage unit 103 of the configuration management server 100 when the user installs the cloud gateway device 300. For example, when the user installs the cloud gateway device 300, the cloud gateway device 300 would send the network address, such as Internet protocol (IP) address of the cloud gateway device 300 and the unique identifier of the cloud gateway device 300 to the configuration management server 100 after the installation is finished. Thus, the configuration management server 100 stores the unique identifier and the network address of the cloud gateway device 300 to the storage unit 103 and associates the unique identifier with the network address of the same cloud gateway device 300.

In one embodiment, the unique identifier of the cloud gateway device 300 can be a hardware identifier of the cloud gateway device 300, a media access control address (MAC address) of the cloud gateway device 300, or the like.

The configuration data determining module 14 is used to determine configuration data corresponding to the obtained unique identifier of the cloud gateway device 300 according to the obtained unique identifier and the relationships between the configuration data and the unique identifiers.

The data distributing module 15 is used to send the configuration data corresponding to the unique identifier to the corresponding cloud gateway device 300 according to the network address of the cloud gateway device 300. Namely, the data distributing module 15 sends the configuration data to the cloud gateway device 300 with the unique identifier corresponding to the configuration data.

The configuration module 16 is used to configure the cloud gateway device 300 according to the configuration data received by the cloud gateway device 300.

The configuration data collection module 17 is used to store the configuration data input by an authorized user of the configuration management server 100 to the storage unit 103 of the configuration management server 100. The configuration data stored in the storage unit 103 includes the configuration data used for a number of cloud gateway device 300. The configuration data collection module 17 further associates the unique identifier of each cloud gateway device 300 with corresponding configuration data according to a configuration requirement of each cloud gateway device 300. The configuration data collection module 17 then stores the relationships between different configuration data and different identifiers into the storage unit 103 of the configuration management server 100. For example, the configuration data stored in the storage unit 103 includes A, B, C, D, E, and F, and the configuration requirement of one cloud gateway device 300 needs configuration data A, B, C. Then the configuration data collection module 17 associates the unique identifier of the cloud gateway device 300 with the corresponding configuration data A, B, C, and stores the relationship between the unique identifier of the cloud gateway device 300 and the corresponding configuration data A, B, C into the storage unit 103.

The login verification module 18 is used to verify an identity of a user in response to a login operation of logging in the management interface 110 of the configuration management device 100 by the user. In at least one embodiment, the login verification module 18 verifies the identity of the user via a user account and password input by the user. The login verification module 18 verifies the user is a valid, authorized, or approved user upon determining that the user account and password input by the user are correct. In the embodiment, when the user logs in the management interface 110 of the configuration management device 100, the user can search the configuration data of one cloud gateway device 300, and search the state of the cloud gateway device 300, and the like, via a search bar 120 of the management interface 110 after logging in the management interface 110.

According to the present disclosure, when the user want to configure the cloud gateway device 300, the user only needs to scan the scan code 301 of the cloud gateway device 300, and the configuration of the cloud gateway device 300 would be completed by the gateway configuration management system 1 as described above.

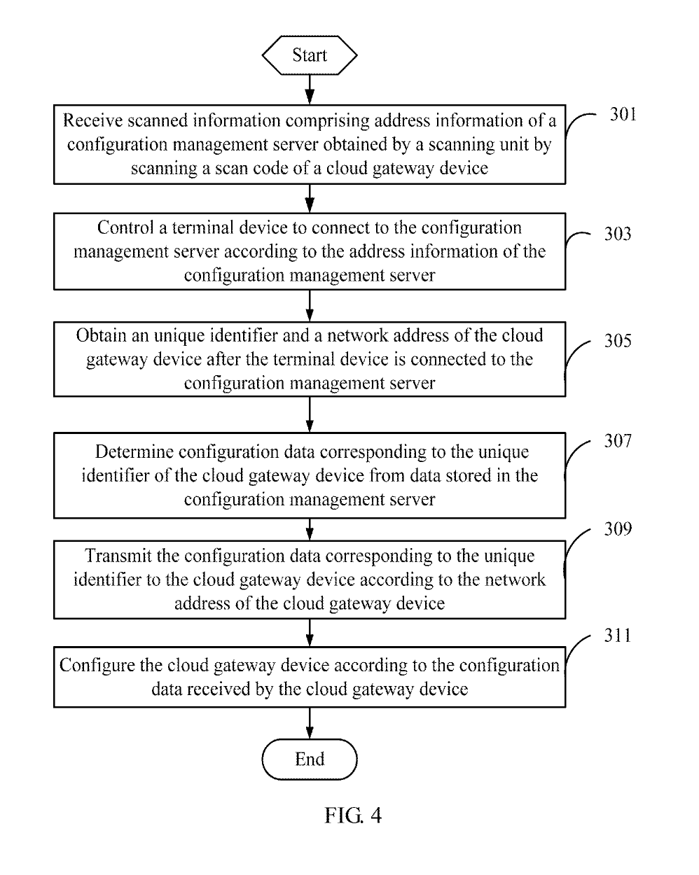

FIG. 4 illustrates a flowchart of the gateway configuration management method. The method is provided by way of example, as there are a variety of ways to carry out the method. The method described below can be carried out using the configurations illustrated in FIG. 1, for example, and various elements of these figures are referenced in explaining the example method. Each block shown in FIG. 4 represents one or more processes, methods, or subroutines carried out in the example method. Additionally, the illustrated order of blocks is by example only and the order of the blocks can be changed. The example method can begin at block 301.

In block 301, a scan information obtaining module 11 receives scanned information including address information of a configuration management server obtained by a scanning unit of a terminal device by scanning a scan code of a cloud gateway device.

In block 303, a connection controlling module controls a communication unit of the terminal device to connect to the configuration management server according to the address information of the configuration management server, thus to connect the terminal device to the configuration management server.

In block 305, an identifier obtaining module obtains an unique identifier of the cloud gateway device and a network address of the cloud gateway device after the terminal device is connected to the configuration management server. In one embodiment, the scan code of the cloud gateway device further includes the unique identifier of the cloud gateway device. When the scanning unit scans the scan code, the scanned information obtained by the scanning unit further includes the unique identifier of the cloud gateway device. The identifier obtaining module obtains the unique identifier of the cloud gateway device from the scan information when the terminal device is connected to the configuration management server. In another embodiment, when the connection controlling module controls the terminal device to connect to the configuration management server according to the address information of the configuration management server, the connection controlling module provides an identifier input box to the terminal device. The identifier obtaining module obtains the unique identifier of the cloud gateway device when the user of the terminal device inputs the unique identifier of the cloud gateway device via the identifier input box.

In block 307, a configuration data determining module determines configuration data corresponding to the unique identifier of the cloud gateway device from data stored in the configuration management server. In detail, the configuration data determining module determines the configuration data corresponding to the obtained unique identifier of the cloud gateway device according to the obtained unique identifier and relationships between the configuration data and the unique identifiers.

In block 309, a data distributing module sends the configuration data corresponding to the unique identifier to the corresponding cloud gateway device according to the network address of the cloud gateway device.

In block 311, a configuration module configures the cloud gateway device according to the configuration data received by the cloud gateway device.

In the embodiment, the gateway configuration management method can further include: a configuration data collection module stores the configuration data input by an authorized user of the configuration management server to the storage unit of the configuration management server; and associates the unique identifier of each cloud gateway device with corresponding configuration data according to a configuration requirement of each cloud gateway device.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A gateway configuration management system comprising:
one or more processing units;
a plurality of modules which are collections of instructions executed by the processing unit, the plurality of modules comprising:
a scan information obtaining module configured to receive scanned information from a scanning unit of a terminal device, the scanned information comprising address information of a configuration management device and obtained by scanning a scan code of a cloud gateway device via the scanning unit;
a connection controlling module configured to control the terminal device to connect to the configuration management server according to the address information of the configuration management server;
an identifier obtaining module configured to obtain a unique identifier of the cloud gateway device and a network address of the cloud gateway device upon the terminal device is connected to the configuration management server;
a configuration data determining module configured to determine configuration data corresponding to the unique identifier of the cloud gateway device from data stored in the configuration management server;
a data distributing module configured to transmit the determined configuration data to the cloud gateway device based on the network address of the cloud gateway device; and
a configuration module configured to configure the cloud gateway device according to the determined configuration data received by the cloud gateway device.

2. The system according to claim 1, wherein configuration data determining module determines the configuration data corresponding to the obtained unique identifier of the cloud gateway device according to the obtained unique identifier and relationships between the configuration data and the unique identifiers stored in a storage unit of the configuration management server.

3. The system according to claim 2, wherein the modules further comprise a configuration data collection module configured to store configuration data input by an authorized user to the storage unit of the configuration management server, and to associate the unique identifier of each cloud gateway device with corresponding configuration data according to a configuration requirement of each cloud gateway device.

4. The system according to claim 2, wherein the unique identifier and the network address of one cloud gateway device are stored in the storage unit of the configuration management server by associating each other, the identifier obtaining module obtains network address associated with the unique identifier of the cloud gateway device after obtaining the unique identifier of the cloud gateway device.

5. The system according to claim 4, wherein the scanned information obtained by the scanning unit further comprises the unique identifier of the cloud gateway device, and the scanned information received by the scan information obtaining module also comprises the unique identifier of the cloud gateway device, the identifier obtaining module obtains the unique identifier of the cloud gateway device from the scan information obtaining module when the terminal device is connected to the configuration management server.

6. The system according to claim 4, wherein the connection controlling module is further configured to provide an identifier input box to the terminal device after controlling the terminal device to connect to the configuration management server, the identifier obtaining module obtains the unique identifier of the cloud gateway device when a user of the terminal device inputs the unique identifier of the cloud gateway device via the identifier input box.

7. The system according to claim 2, wherein the modules further comprise a login verification module configured to verify an identity of a user in response to a login operation of logging in a management interface of the configuration management device by the user, the management interface provided for the user to search the configuration data of one cloud gateway device and the state of the cloud gateway device.

8. A gateway configuration management method comprising:
receiving scanned information from a scanning unit of a terminal device, the scanned information comprising address information of a configuration management device and obtained by scanning a scan code of a cloud gateway device via the scanning unit;
controlling the terminal device to connect to the configuration management server according to the address information of the configuration management server;
obtaining a unique identifier of the cloud gateway device and a network address of the cloud gateway device upon the terminal device is connected to the configuration management server;
determining configuration data corresponding to the unique identifier of the cloud gateway device from data stored in the configuration management server;
transmitting the determined configuration data to the cloud gateway device based on the network address of the cloud gateway device; and
configuring the cloud gateway device according to the determined configuration data received by the cloud gateway device.

9. The method according to claim 8, wherein the step of determining configuration data corresponding to the unique identifier of the cloud gateway device from data stored in the configuration management server comprising:
determining the configuration data corresponding to the obtained unique identifier of the cloud gateway device according to the obtained unique identifier and relationships between the configuration data and the unique identifiers stored in a storage unit of the configuration management server.

10. The method according to claim 9, further comprising:
storing the configuration data input by an authorized user to the storage unit of the configuration management server; and
associating the unique identifier of each cloud gateway device with the corresponding configuration data according to a configuration requirement of each cloud gateway device.

11. The method according to claim 9, wherein the unique identifier and the network address of one cloud gateway device are stored in the storage unit of the configuration management server by associating each other, the step of obtaining an unique identifier of the cloud gateway device and a network address of the cloud gateway device comprising:
obtaining the network address associated with the unique identifier of the cloud gateway device after obtaining the unique identifier of the cloud gateway device.

12. The method according to claim 9, wherein the scanned information obtained by the scanning unit further comprises the unique identifier of the cloud gateway device, the step of obtaining an unique identifier of the cloud gateway device and a network address of the cloud gateway device comprising:
obtaining the unique identifier of the cloud gateway device from the received scanned information.

13. The method according to claim 9, further comprising:
providing an identifier input box to the terminal device after controlling the terminal device to connect to the configuration management server; and
obtaining the unique identifier of the cloud gateway device when a user of the terminal device inputs the unique identifier of the cloud gateway device via the identifier input box.

14. A non-transitory storage medium having stored thereon instructions that, when executed by at least one processor, causes the least one processor to execute instructions of a method for automatically configuring a cloud gateway device, the method comprising:
receiving scanned information from a scanning unit of a terminal device, the scanned information comprising address information of a configuration management device and obtained by scanning a scan code of a cloud gateway device via the scanning unit;
controlling the terminal device to connect to the configuration management server according to the address information of the configuration management server;
obtaining a unique identifier of the cloud gateway device and a network address of the cloud gateway device upon the terminal device is connected to the configuration management server;
determining configuration data corresponding to the unique identifier of the cloud gateway device from data stored in the configuration management server;
transmitting the determined configuration data to the cloud gateway device based on the network address of the cloud gateway device; and
configuring the cloud gateway device according to the determined configuration data received by the cloud gateway device.

15. The non-transitory storage medium according to claim 14, wherein the step of determining configuration data corresponding to the unique identifier of the cloud gateway device from data stored in the configuration management server comprising:
determining the configuration data corresponding to the obtained unique identifier of the cloud gateway device according to the obtained unique identifier and relationships between the configuration data and the unique identifiers stored in a storage unit of the configuration management server.

16. The non-transitory storage medium according to claim 15, wherein the method further comprising:
storing the configuration data input by an authorized user to the storage unit of the configuration management server; and
associating the unique identifier of each cloud gateway device with the corresponding configuration data according to a configuration requirement of each cloud gateway device.

17. The non-transitory storage medium according to claim 15, wherein the unique identifier and the network address of one cloud gateway device are stored in the storage unit of the configuration management server by associating each other, the step of obtaining an unique identifier of the cloud gateway device and a network address of the cloud gateway device comprising:
obtaining the network address associated with the unique identifier of the cloud gateway device after obtaining the unique identifier of the cloud gateway device.

18. The non-transitory storage medium according to claim 15, wherein the scanned information obtained by the scanning unit further comprises the unique identifier of the cloud gateway device, the step of obtaining an unique identifier of the cloud gateway device and a network address of the cloud gateway device comprising:
obtaining the unique identifier of the cloud gateway device from the received scanned information.

19. The non-transitory storage medium according to claim 15, wherein the method further comprising:
providing an identifier input box to the terminal device after controlling the terminal device to connect to the configuration management server; and
obtaining the unique identifier of the cloud gateway device when a user of the terminal device inputs the unique identifier of the cloud gateway device via the identifier input box.
